(19) United States
(12) Patent Application Publication
(10) Pub. No.: US 2025/0021768 A1
(43) Pub. Date: Jan. 16, 2025

(54) EXTRACTING MEMORIES FROM A USER INTERACTION HISTORY

(71) Applicant: Microsoft Technology Licensing, LLC, Redmond, WA (US)

(72) Inventors: Umesh MADAN, Bellevue, WA (US); Samuel Edward SCHILLACE, Portola Valley, CA (US); Brian Scott KRABACH, Snohomish, WA (US)

(73) Assignee: Microsoft Technology Licensing, LLC, Redmond, WA (US)

(21) Appl. No.: 18/472,103

(22) Filed: Sep. 21, 2023

Related U.S. Application Data
(60) Provisional application No. 63/513,696, filed on Jul. 14, 2023.
(60) Provisional application No. 63/514,776, filed on Jul. 20, 2023.

(51) Int. Cl. G06F 40/40; G06N 3/0455; G06N 3/0475

(52) U.S. Cl. CPC G06F 40/40; G06N 3/0455; G06N 3/0475

(57) ABSTRACT

A computing system is provided, comprising at least one processor configured to receive a user interaction history of a user, extract memories from the user interaction history, consolidate the memories into memory clusters, cause a prompt interface for a trained model to be presented, receive, via the prompt interface, an instruction from the user for the trained model to generate an output, generate a prompt based on the memory clusters and the instruction from the user, provide the prompt to the trained model, generate, in response to the prompt, a response via the trained model, and output the response to the user.

### CROSS REFERENCE TO RELATED APPLICATIONS

This application claims priority to U.S. Provisional Patent Application No. 63/513,696, filed Jul. 14, 2023, and to U.S. Provisional Patent Application No. 63/514,776, filed Jul. 20, 2023, the entirety of each of which is hereby incorporated herein by reference for all purposes.

### BACKGROUND

Recently, large language models (LLMs) have been developed that generate natural language responses in response to prompts entered by users. LLMs are routinely incorporated into chatbots, which are computer programs designed to interact with users in a natural, conversational manner. Chatbots facilitate efficient and effective interaction with users, often for the purpose of providing information or answering questions.

Notwithstanding the advancements and widespread usage of chatbots, a significant issue persists in their operation: the loss of context from the user interaction history. This challenge primarily arises from the inability of chatbots to effectively capture, store, and leverage previous interactions with a user. Chatbots often lack the capability to refer back to past conversations and bring forward relevant information to a current interaction. This limitation can result in a disjointed user experience and a conversational deficit, where context and continuity are lost.

### SUMMARY

To address the above issues, a computing system is provided, comprising processing circuitry configured to receive a user interaction history of a user, extract memories from the user interaction history, consolidate the memories into memory clusters, cause a prompt interface for a trained generative model to be presented, receive, via the prompt interface, an instruction from the user for the trained generative model to generate an output, generate a prompt based on the memory clusters and the instruction from the user, provide the prompt to the trained generative model, generate, in response to the prompt, a response via the trained generative model, and output the response to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is a schematic view showing a computing system according to a first example implementation.

FIG. 1B is a schematic view showing a computing system according to a second example implementation.

FIG. 2 is a schematic view showing an input and an output of the prompt generator of FIG. 1A according to an example implementation.

FIG. 3 is a schematic view showing an input and an output of the memory-extracting trained model of FIG. 1A in generating a synthetic memory from a persistent user interaction history according to an example implementation.

FIG. 4 is a schematic view showing an input and an output of the memory-extracting trained model of FIG. 1A in generating a synthetic memory from a memory cluster according to an example implementation.

FIG. 5 shows an example graphical user interface of the computing system of FIG. 1A, illustrating the incorporation of information from the persistent user interaction history in the response.

FIG. 6 shows a flowchart for a method according to one example implementation.

FIG. 7 shows a schematic view of an example computing environment in which the computing system of FIG. 1A or 1B may be enacted.

### DETAILED DESCRIPTION

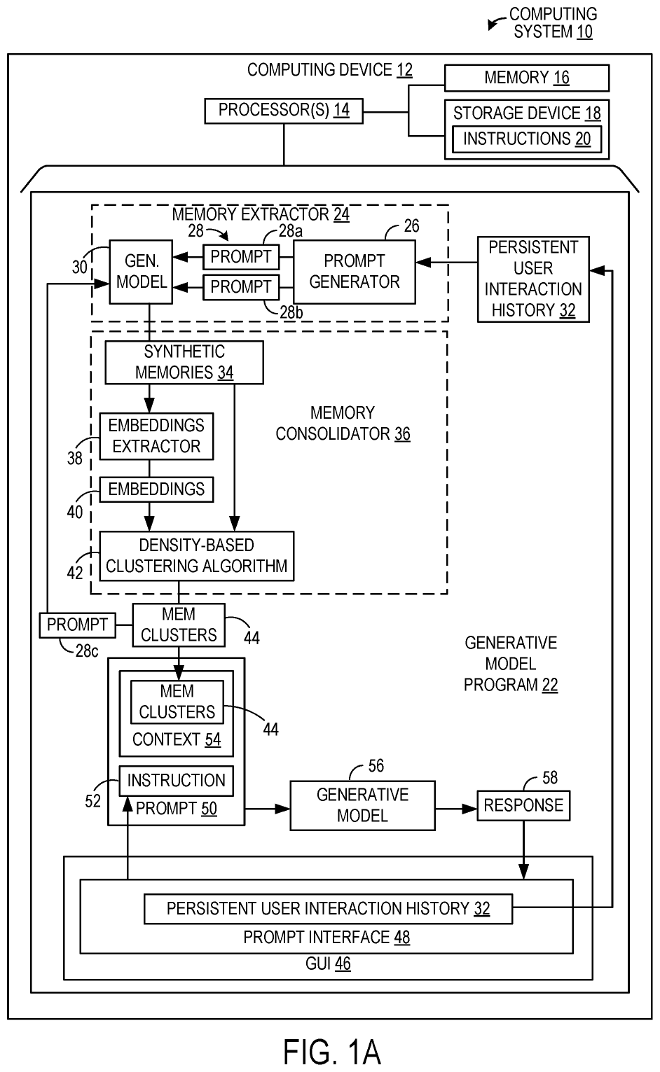

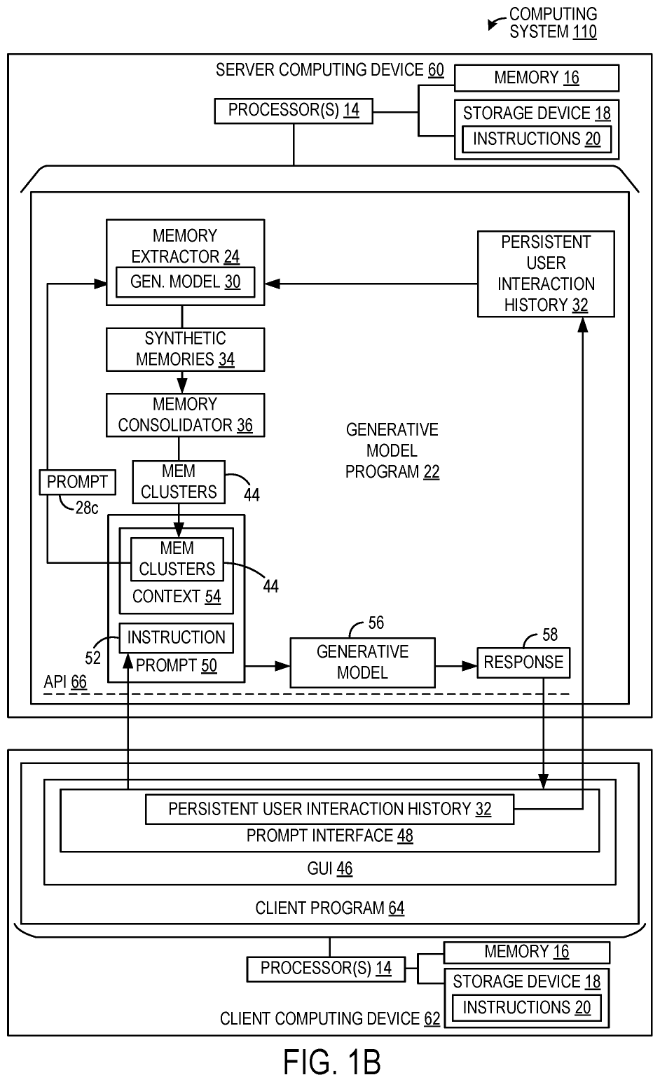

To address the issues described above, FIG. 1A illustrates a schematic view of a computing system 10 according to a first example implementation. The computing system 10 includes a computing device 12 having processing circuitry 14, memory 16, and a storage device 18 storing instructions 20. In this first example implementation, the computing system 10 takes the form of a single computing device 12 storing instructions 20 in the storage device 18, including a trained generative model program 22 that is executable by the processing circuitry 14 to perform various functions including memory extraction and memory consolidation by a memory extractor 24 and a memory consolidator 36, respectively.

The processing circuitry 14 may be configured to cause a prompt interface 48 for at least a trained generative model 56 to be presented. In some instances, the prompt interface 48 may be a portion of a graphical user interface (GUI) 46 for accepting user input and presenting information to a user. In other instances, the prompt interface 48 may be presented in non-visual formats such as an audio interface for receiving and/or outputting audio, such as may be used with a digital assistant. In yet another example the prompt interface 48 may be implemented as a prompt interface application programming interface (API). In such a configuration, the input to the prompt interface 48 may be made by an API call from a calling software program to the prompt interface API, and output may be returned in an API response from the prompt interface API to the calling software program. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the prompt interface API (e.g., prompt interface 48) for the trained generative model 56.

In general, the processing circuitry 14 may be configured to receive, via the prompt interface 48 (in some implementations, the prompt interface API), an instruction 52, which is incorporated into a prompt 50. The trained generative model 56 receives the prompt 50, which includes the instruction 52, and produces a response 58. It will be understood that the instruction 52 may also be generated by and received from a software program, rather than directly from a human user. The prompt 50 may be inputted into the trained generative model 56 by an API call from a client to a server hosting the trained generative model 56, and the response 58 may be received in an API response from the server. Alternatively, the input of the prompt 50 into the trained generative model 56 and the reception of the response 58 from the trained generative model 56 may performed at one computing device.

The prompt generator 26 receives input of a persistent user interaction history 32 of a user, which is not limited to, but exemplified by a persistent chat history of an interaction between a chatbot and a user. The user interaction history may include messages in the chat history as well as contextual information used to generate the messages. The contextual information in the persistent user interaction history 32 may include transaction histories, browsing histories, social media activity histories, game play histories, text input histories, and other contextual information that were used to generate the prompts sent to the generative model as input during the user interactions. Thus, the persistent user interaction history 32 can be configured as a record or log capturing the entirety of messages, queries, responses, and other relevant information exchanged during the interaction timeline. The persistent user interaction history 32 may also include timestamps and any additional metadata associated with each interaction. Alternatively, a subset of the aforementioned contextual information may be included in the persistent user interaction history 32. The persistent user interaction history 32 can be configured to save and retain a user interaction history across multiple interaction sessions. The persistent user interaction history 32 is said to be persistent because it can retain user interaction histories from prior sessions in this manner, rather than deleting or forgetting such prior user interaction histories in an ephemeral manner.

Responsive to receiving the persistent user interaction history 32, the prompt generator 26 generates one or more memory-extracting prompts 28 to be inputted into the memory-extracting trained model 30, which may be identical to the trained generative model 56 or separate from the trained generative model 56. Both the trained model 30 and the trained generative model 56 are generative models that have been configured through machine learning to receive input that includes natural language text and generate output that includes natural language text in response to the input. It will be appreciated that the memory-extracting trained model 30 and the trained generative model 56 can be large language models (LLMs) having tens of millions to billions of parameters, non-limiting examples of which include GPT-3 and BLOOM, or alternatively configured as other architectures of generative models, including various forms of diffusion models, generative adversarial networks, and multi-modal models. Either or both of the memory-extracting trained model 30 and the trained generative model 56 can be multi-modal generative language models configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-1, GPT-4, and LLaMA. Further, either or both of the memory-extracting trained model 30 and the trained generative model 56 can be configured to have a generative pre-trained transformer architecture, examples of which are used in the GPT-3 and GPT-4 models.

The memory-extracting prompts 28 include instructions to transform the persistent user interaction history 32 into synthetic memories 34, which are stored in a memory bank of the storage device 18. The persistent user interaction history 32 may be incorporated into one memory-extracting prompt 28a, or divide the persistent user interaction history 32 into a plurality of parts, and incorporate these parts into two or more memory-extracting prompts 28a, 28b, respectively, to extract synthetic memories 34 from the plurality of parts. As used herein the term “memories” refers to output generated by a generative model in response to a memory-extracting prompt including a portion of the user interaction history (or memory or memories generated therefrom) between a user and software components of a computing system. Depending on the configuration of the generative model, as described below, the memories can include natural language text, images, and/or audio. The prompt can include instructions The memories are referred to as “synthetic” because they are programmatically generated according to the processes described herein from the raw data in the user interaction history or memories thereof by the generative model.

For example, the division of the persistent user interaction history 32 may be performed according to criteria such as the subject of the user interactions, the times at which the user interactions occurred, or the platforms or application programs via which the user interactions took place. In one implementation, to divide email threads based on the subject of the emails, the persistent user interaction history 32 may be divided into distinct groups: one containing work-related e-mails, and another containing personal-related e-mails. For example, these groups may be established based on the user account (work or personal) or based on a trained subject classifier that reads recipient sender subject and/or bodies of emails to classify the emails into work or personal groups. In a different implementation, the persistent user interaction history 32 may be segmented by specific time periods, such as days, weeks, months, or years. In yet another implementation, the persistent user interaction history 32 may be categorized to group e-mail interactions together in one part, group text message interactions together in another part, and group user interactions with application programs such as word processors, spreadsheets, or web browsers in other respective parts.

As illustrated in the subsequent examples, the extraction of synthetic memories 34 by the memory-extracting trained model 30 is not the mere recording or filtering of raw data, but the summary or encapsulation of the essence of the interactions in the persistent user interaction history 32 in accordance with instructions in a prompt 28. As such, the synthetic memories 34 offer an intelligent, context-aware reflection of the interactions in the persistent user interaction history 32.

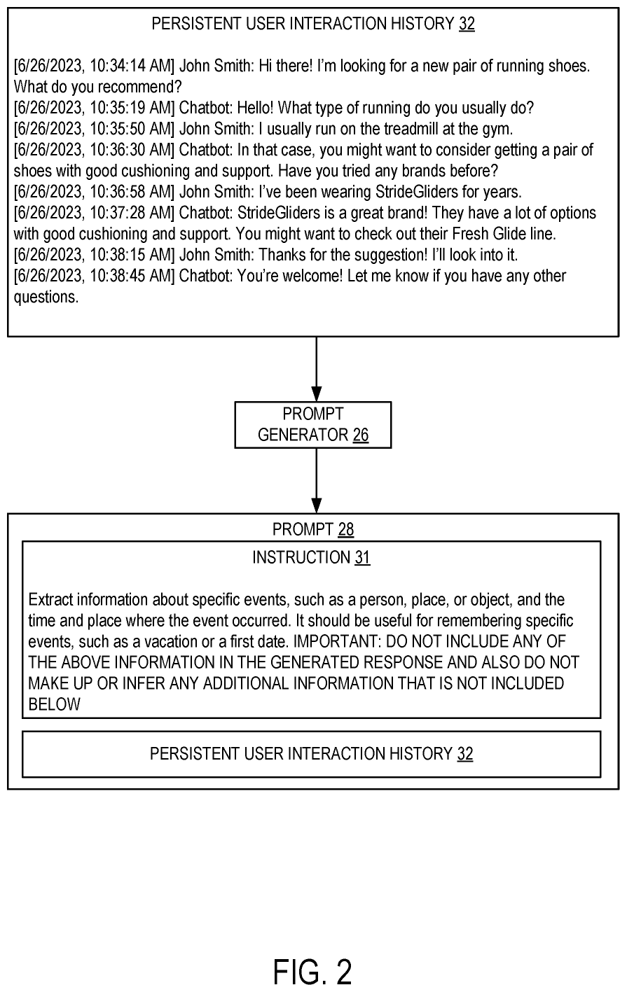

Turning to FIG. 2, an example of a persistent user interaction history 32 and a memory-extracting prompt 28 are shown, in which the prompt generator 26 generates a memory-extracting prompt 28 which incorporates the persistent user interaction history 32. In this example, the user John Smith asks the chatbot for recommendations for a new pair of running shoes. The persistent user interaction history 32 includes timestamps indicating when each message was sent or received. The generated memory-extracting prompt 28 includes the persistent user interaction history 32 and an instruction 31 to extract information about specific events, such as person, place, or object, and the time and place where the event occurred. The instruction 31 may include commands to extract information about the participants of the chat session as well as specific objects, specific people, and/or specific places that were mentioned during the user interaction session. The instruction 31 may also include a memory-extracting action indicating the manner in which the memory is to be generated, such as summarize, categorize, outline, highlight, or spotlight, for example, one of the persons, places, objects, or times in the user interaction history or memories thereof. Further, the instruction 31 can include a command to find portions of a one or a group of memories that are related to a particular topic (person, place, object, time, etc.) and connect and generate a new memory (or consolidate the group of memories into a replacement memory) that summarizes, categorizes, outlines, highlights, or spotlights the topic. In this way, new memories can be generated based on aspects of prior memories according to the instruction 31.

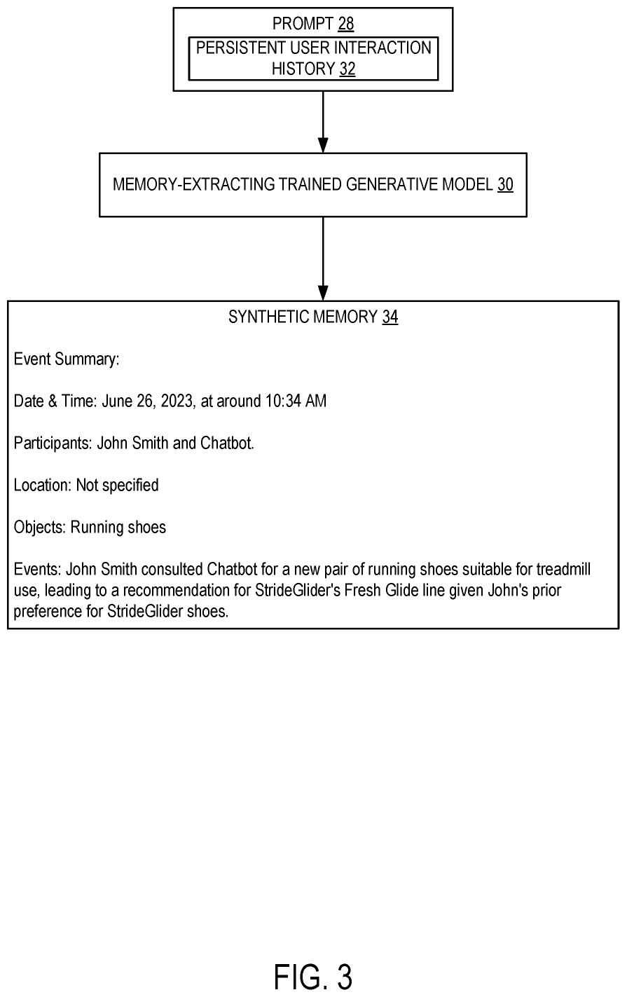

Turning to FIG. 3, an example is illustrated of the synthetic memory 34 generated by the memory-extracting trained model 30 based on the memory-extracting prompt 28 generated in the example of FIG. 2. The memory-extracting trained model 30 follows the instructions 31 in the memory-extracting prompt 28 to extract, from the persistent user interaction history 32, information about the chat, including the participants and the time when the chat occurred. In this example, the synthetic memory 34 generated by the memory-extracting trained model 30 indicates that a conversation happened between John Smith and the chatbot at around 10:34 AM on Jun. 26, 2023. The location was unspecified, and the objects discussed were running shoes. The brief summary in the synthetic memory 34 indicates that John Smith consulted the chatbot for a new pair of running shoes suitable for treadmill use, leading to a recommendation for StrideGlider's Fresh Glide line given John's prior preference for StrideGlider shoes.

Returning to FIG. 1A, the synthetic memories 34, which include summaries of past user interaction sessions, are processed by the memory consolidator 36 to be consolidated into memory clusters 44. The memory consolidator 36 comprises an embeddings extractor 38 configured to extract high-dimensional vectors or embeddings 40 from the synthetic memories 34 and store the embeddings 40 in a memory bank of the storage device 18, and a density-based clustering algorithm 42 configured to group the synthetic memories 34 into memory clusters 44 based on relative distances between the embeddings 40. The memory clusters 44 with the consolidated memories are then stored in a memory bank of the storage device 18. The synthetic memories 34 which were consolidated into the memory clusters 44 may be subsequently deleted from the storage device 18.

The memory consolidator 36 may run in the background on active memory by operating continuously and concurrently with other processes that are running on the processing circuitry 14, utilizing active or volatile memory 16 for the operation of the memory consolidator 36, so as to utilize the processor cycles that are not being used by foreground processes, which may include user-facing applications or services. Accordingly, memory consolidation may be performed by the memory consolidator 36 without interrupting any active tasks that a user is engaged in on the computing system 10.

The embeddings 40 may be contextual embeddings which capture the context of words within a sentence, sentence embeddings which represent entire sentences as vectors, entity embeddings which represent entities such as people, places, or organizations, and/or dialogue embeddings which represent the interactions and overall context within a chat session.

The density-based clustering algorithm 42 is configured to spatially organize or cluster the embeddings 40 by considering their relative distances in the embeddings space, assuming that embeddings 40 which are closer together in the high-dimensional space tend to originate from similar or related interactions. Accordingly, the combination of the embeddings extractor 38 and the density-based clustering algorithm 42 aids in the utilization of past interaction data in the current interactions of the chatbot. The density-based clustering algorithm 42 may be DBSCAN (Density-Based Spatial Clustering of Applications with Noise), HDBSCAN (Hierarchical DBSCAN), or OPTICS (Ordering Points to Identify the Clustering Structure), for example.

The memory clusters 44 are subsequently incorporated into the prompt 50 as a prompt context 54 along with the instruction 52 from the user, before the prompt 50 is inputted into the trained generative model 56 to generate the response 58. The response 58 is displayed on the prompt interface 48 as part of the persistent user interaction history 32. The memory clusters 44 may be further consolidated by inputting a memory-extracting prompt 28c including the memory clusters 44 into the memory extractor 24.

It will be appreciated that, while FIG. 1A depicts an example of the extraction of embeddings 40 from synthetic memories 34 which include summaries of past chat sessions between the user and the chatbot, it will be appreciated that the format of the data, from which the embeddings 40 are extracted, is not particularly limited, and any data, whether textual or structured data types, including JSON-formatted data, may be inputted into the embeddings extractor 38 to extract embeddings 40, so that the data are subsequently clustered into memory clusters 44. Moreover, the memory consolidator 36 may be configured to consolidate not only synthetic memories 34 extracted from a chat history, but also extracted from other types of user interaction histories, including transaction histories, browsing histories, social media activity histories, game play histories, text input histories, and others.

Furthermore, the memory consolidator 36 may be configured to consolidate not only synthetic memories 34 which are semantic data such as natural language text, but also multi-modal synthetic memories 34 which encompass not only text but also images and audio. Such multi-model synthetic memories 34 may be extracted from a memory-extracting trained model 30 which is configured as a multi-modal generative model.

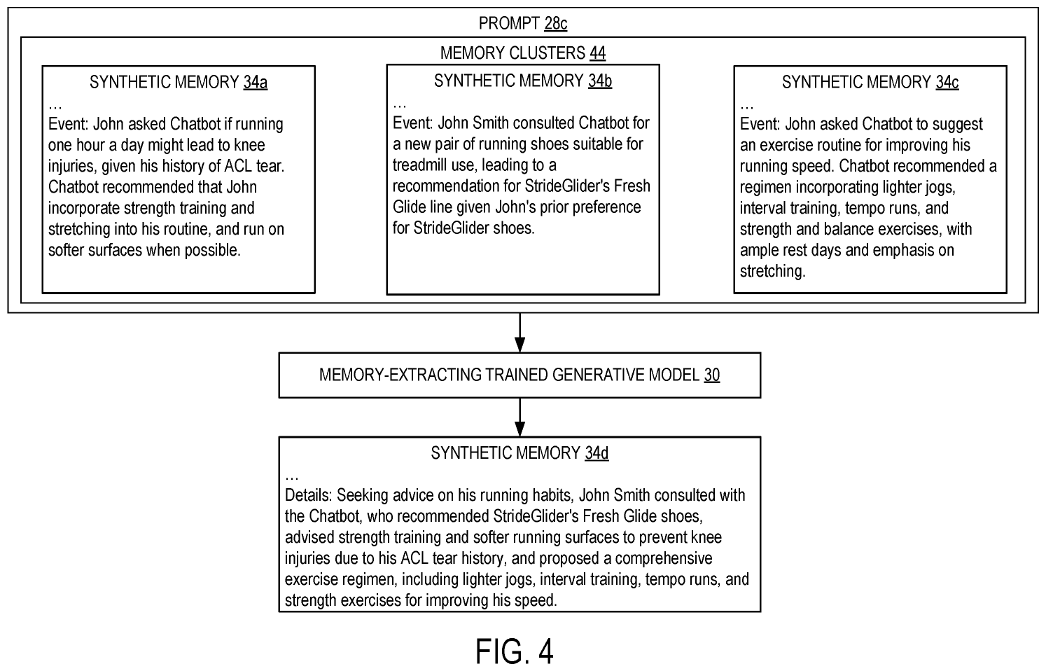

Turning to FIG. 4, an example is illustrated of memory clusters 44 that are further consolidated through a memory-extracting prompt 28c that includes the memory clusters 44. In this example the memory clusters 44 include a first synthetic memory 34a about a chat in which John Smith consulted the chatbot about reducing his risk of injuries during workouts, a second synthetic memory 34b about a chat in which John Smith consulted the chatbot about a recommendation for a new pair of running shoes that were suitable for treadmill use, and a third synthetic memory 34c about a chat in which John Smith asked about a workout routine to improve his running speeds. The memory-extracting prompt 28c includes instructions to consolidate the synthetic memories 34a-c. The memory-extracting trained model 30 processes the memory-extracting prompt 28c to output a consolidated synthetic memory 34d which summarizes the first, second and third synthetic memories 34a-c: “Seeking advice on his running habits, John Smith consulted with the chatbot, who recommended StrideGlider's Fresh Glide shoes, advised strength training and softer running surfaces to prevent knee injuries due to his anterior cruciate ligament (ACL) tear history, and proposed a comprehensive exercise regimen, including lighter jogs, interval training, tempo runs, and strength exercises for improving his speed”.

Turning to FIG. 1B, a computing system 110 according to a second example implementation is illustrated, in which the computing system 110 includes a server computing device 60 and a client computing device 62. Here, both the server computing device 60 and the client computing device may include respective processing circuitry 14, memory 16, and storage devices 18. Description of identical components to those in FIG. 1A will not be repeated. The client computing device 62 may be configured to present the prompt interface 48 as a result of executing a client program 64 by the processing circuitry 14 of the client computing device 62. The client computing device 62 may be responsible for communicating between the user operating the client computing device 62 and the server computing device 60 which executes the trained model program 22 and contains the trained generative models 30 and 56, via an application programming interface (API) 66 of the trained model program 22. The client computing device 62 may take the form of a personal computer, laptop, tablet, smartphone, smart speaker, etc. The same processes described above with reference to FIG. 1A may be performed, except in this case the instruction 52 and response 58 may be communicated between the server computing device 60 and the client computing device via a network such as the Internet.

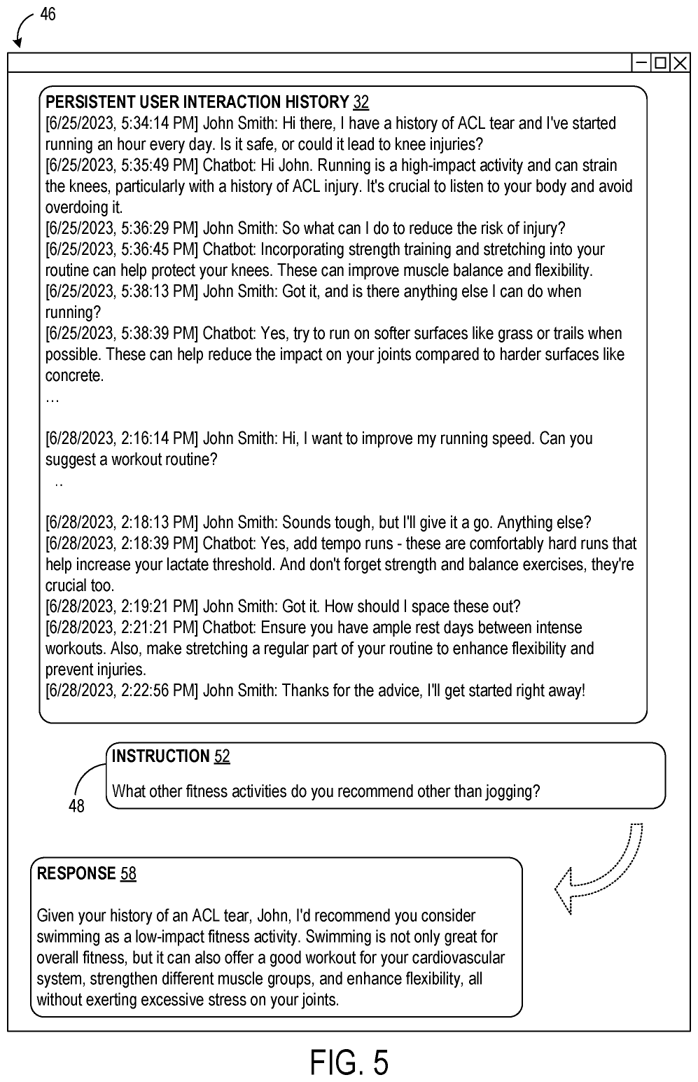

Turning to FIG. 5, an example is described of a chat between a user and a chatbot, in which the chatbot recalls information from a past conversation with the user. In this example, the persistent user interaction history 32 includes past exchanges in which John Smith anxiously mentioned his history of ACL tear as he asked if running was a safe workout activity for him. Therefore, when the user asked the chatbot about other recommended fitness activities in an instruction 52 incorporated into the prompt 50, the trained generative model 56 generated a response 58 including a recollection about his history of ACL tear, and the outputted fitness recommendations in the generated response 58 took this recollection into account.

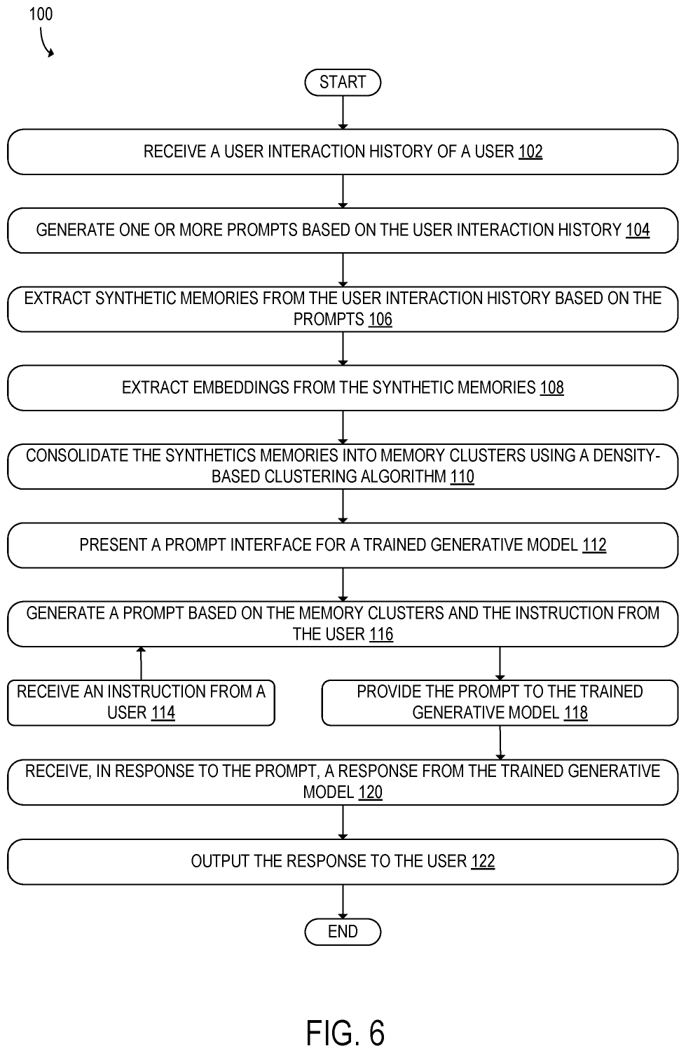

FIG. 6 shows a flowchart for a method 100 for extracting and clustering synthetic memories from a user interaction history. The method 100 may be implemented by the computing system 10 or 110 illustrated in FIGS. 1A and 1B, or via other suitable hardware and software.

At step 102, a user interaction history of a user is received. At step 104, one or more prompts are generated based on the user interaction history. At step 106, synthetic memories are extracted from the user interaction history based on the prompts. At step 108, high-dimensional vectors or embeddings are extracted from the synthetic memories. At step 110, the synthetic memories are consolidated into memory clusters using a density-based clustering algorithm. At step 112, a prompt interface for a trained generative model is presented. At step 114, an instruction is received from a user, via the prompt interface, to generate an output. At step 116, a prompt is generated based on the memory clusters and the instruction from the user. At step 118, the prompt is provided to the trained generative model. At step 120, in response to the prompt, a response is received from the trained generative model. At step 122, the response is outputted to the user.

The above-described system and method address the context loss problem in user interactive systems by leveraging historical user interactions and integrating them into current and future user interaction sessions, thereby offering a context-rich, personalized, and meaningful conversational experience.

In some embodiments, the methods and processes described herein may be tied to a computing system of one or more computing devices. In particular, such methods and processes may be implemented as a computer-application program or service, an application-programming interface (API), a library, and/or other computer-program product.

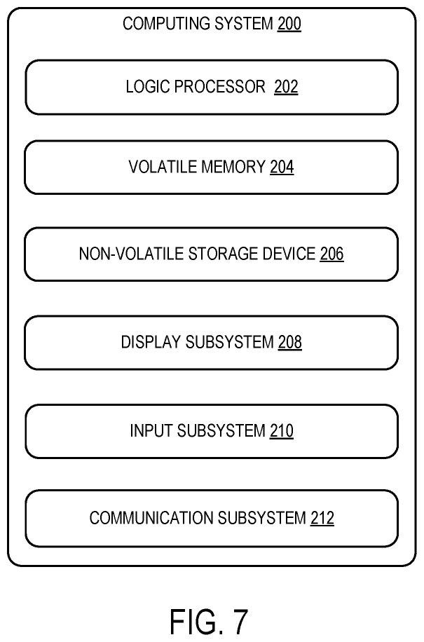

FIG. 7 schematically shows a non-limiting embodiment of a computing system 200 that can enact one or more of the methods and processes described above. Computing system 200 is shown in simplified form. Computing system 200 may embody the computing system 10 or 110 described above and illustrated in FIGS. 1B and 1B, respectively. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 7.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 202.

Non-volatile storage device 206 includes one or more physical devices configured to hold instructions executable by the processing circuitry to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 200 to send and/or receive messages to and/or from other devices via a network such as the Internet.

Below, several aspects of the subject application are additionally described. One aspect provides a computing system comprising at least one processor configured to receive a user interaction history of a user, extract memories from the user interaction history, consolidate the memories into memory clusters, cause a prompt interface for a trained generative model to be presented, receive, via the prompt interface, an instruction from the user for the trained generative model to generate an output, generate a prompt based on the memory clusters and the instruction from the user, provide the prompt to the trained generative model, receive, in response to the prompt, a response from the trained generative model, and output the response to the user. In this aspect, additionally or alternatively, the trained generative model may be a trained generative language model. In this aspect, additionally or alternatively, the trained generative language model may be a generative pre-trained transformer model. In this aspect, additionally or alternatively, the trained generative model may be a multi-modal model configured to receive multi-modal input including natural language text as a first mode of input and at least one of image, video, and/or audio as a second mode of input and generate output including natural language text output based on the multi-modal input. In this aspect, additionally or alternatively, the memories may be clustered into memory clusters via a density-based clustering algorithm by extracting embeddings from the memories and cluster the embeddings using the density-based clustering algorithm. In this aspect, additionally or alternatively, the embeddings may be at least one selected from the group of context embeddings, sentence embeddings, entity embeddings, and dialogue embeddings. In this aspect, additionally or alternatively, the memory clusters may be incorporated into a context of the prompt. In this aspect, additionally or alternatively, the user interaction history may be a persistent user interaction history between the user and the trained generative model which is saved and retained across multiple user interaction sessions. In this aspect, additionally or alternatively, the memories may be extracted from the user interaction history using a memory-extracting trained generative model and a memory-extracting prompt including an instruction to extract information about specific objects, specific people, and/or specific places that were mentioned during user interaction sessions of the user interaction history. In this aspect, additionally or alternatively, the memory clusters may be further consolidated using the memory-extracting trained generative model. In this aspect, additionally or alternatively, the user interaction history may be divided into a plurality of parts, and the memories may be extracted from the plurality of parts.

Another aspect provides a method comprising receiving a user interaction history of a user, extracting memories from the user interaction history, consolidating the memories into memory clusters, causing a prompt interface for a trained generative model to be presented, receiving, via the prompt interface, an instruction from the user for the trained generative model to generate an output, generating a prompt based on the memory clusters and the instruction from the user, providing the prompt to the trained generative model, receiving, in response to the prompt, a response from the trained generative model, and outputting the response to the user. In this aspect, additionally or alternatively, the trained generative model may be a trained generative language model. In this aspect, additionally or alternatively, the trained generative language model may be a generative pre-trained transformer model. In this aspect, additionally or alternatively, the memories may be clustered into memory clusters by extracting embeddings from the memories and clustering the embeddings using the density-based clustering algorithm. In this aspect, additionally or alternatively, the embeddings may be at least one selected from the group of context embeddings, sentence embeddings, entity embeddings, and dialogue embeddings. In this aspect, additionally or alternatively, the user interaction history may be a persistent user interaction history between the user and the trained generative model which is saved and retained across multiple user interaction sessions. In this aspect, additionally or alternatively, the memories may be extracted from the user interaction history using a memory-extracting trained generative model and a memory-extracting prompt including an instruction to extract information about specific objects, specific people, and/or specific places that were mentioned during user interaction sessions of the user interaction history. In this aspect, additionally or alternatively, the memory clusters may be further consolidated using the memory-extracting trained generative model.

Another aspect provides a computing system comprising at least one processor configured to execute a prompt interface application programming interface (API) for a trained generative model, the trained generative model being a large model having a generative pre-trained transformer architecture, receive a user interaction history of a user, extract memories from the user interaction history, consolidate the memories into memory clusters in a process running in a background on active memory, cause a prompt interface for the trained generative model to be presented, receive, via the prompt interface API, an instruction from the user for the trained generative model to generate an output, generate a prompt based on the memory clusters and the instruction from the user, provide the prompt to the trained generative model, receive, in response to the prompt, a response from the trained generative model, and output the response via the prompt interface API.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
at least one processor configured to:
receive a user interaction history of a user;
extract memories from the user interaction history;
consolidate the memories into memory clusters;
cause a prompt interface for a trained generative model to be presented;
receive, via the prompt interface, an instruction from the user for the trained generative model to generate an output;
generate a prompt based on the memory clusters and the instruction from the user;
provide the prompt to the trained generative model;
receive, in response to the prompt, a response from the trained generative model; and
output the response to the user.

2. The computing system of claim 1, wherein the trained generative model is a trained generative language model.

3. The computing system of claim 2, wherein the trained generative language model is a generative pre-trained transformer model.

4. The computing system of claim 1, wherein the trained generative model is a multi-modal model configured to receive multi-modal input including natural language text as a first mode of input and at least one of image, video, and/or audio as a second mode of input and generate output including natural language text output based on the multi-modal input.

5. The computing system of claim 1, wherein the memories are clustered into memory clusters via a density-based clustering algorithm by extracting embeddings from the memories and cluster the embeddings using the density-based clustering algorithm.

6. The computing system of claim 5, wherein the embeddings are at least one selected from the group of context embeddings, sentence embeddings, entity embeddings, and dialogue embeddings.

7. The computing system of claim 1, wherein the memory clusters are incorporated into a context of the prompt.

8. The computing system of claim 1, wherein the user interaction history is a persistent user interaction history between the user and the trained generative model which is saved and retained across multiple user interaction sessions.

9. The computing system of claim 1, where the memories are extracted from the user interaction history using a memory-extracting trained generative model and a memory-extracting prompt including an instruction to extract information about specific objects, specific people, and/or specific places that were mentioned during user interaction sessions of the user interaction history.

10. The computing system of claim 9, wherein the memory clusters are further consolidated using the memory-extracting trained generative model.

11. The computing system of claim 1, wherein
the user interaction history is divided into a plurality of parts; and
the memories are extracted from the plurality of parts.

12. A method comprising:
receiving a user interaction history of a user;
extracting memories from the user interaction history;
consolidating the memories into memory clusters;
causing a prompt interface for a trained generative model to be presented;
receiving, via the prompt interface, an instruction from the user for the trained generative model to generate an output;
generating a prompt based on the memory clusters and the instruction from the user;
providing the prompt to the trained generative model;
receiving, in response to the prompt, a response from the trained generative model; and
outputting the response to the user.

13. The method of claim 12, wherein the trained generative model is a trained generative language model.

14. The method of claim 13, wherein the trained generative language model is a generative pre-trained transformer model.

15. The method of claim 12, wherein the memories are clustered into memory clusters by extracting embeddings from the memories and clustering the embeddings using the density-based clustering algorithm.

16. The method of claim 15, wherein the embeddings are at least one selected from the group of context embeddings, sentence embeddings, entity embeddings, and dialogue embeddings.

17. The method of claim 12, wherein the user interaction history is a persistent user interaction history between the user and the trained generative model which is saved and retained across multiple user interaction sessions.

18. The method of claim 12, where the memories are extracted from the user interaction history using a memory-extracting trained generative model and a memory-extracting prompt including an instruction to extract information about specific objects, specific people, and/or specific places that were mentioned during user interaction sessions of the user interaction history.

19. The method of claim 18, wherein the memory clusters are further consolidated using the memory-extracting trained generative model.

20. A computing system comprising:
at least one processor configured to:
execute a prompt interface application programming interface (API) for a trained generative model, the trained generative model being a large model having a generative pre-trained transformer architecture;
receive a user interaction history of a user;
extract memories from the user interaction history;
consolidate the memories into memory clusters in a process running in a background on active memory;
cause a prompt interface for the trained generative model to be presented;
receive, via the prompt interface API, an instruction from the user for the trained generative model to generate an output;
generate a prompt based on the memory clusters and the instruction from the user;
provide the prompt to the trained generative model;
receive, in response to the prompt, a response from the trained generative model; and
output the response via the prompt interface API.
